(19) United States
(12) Patent Application Publication
(10) Pub. No.: US 2014/0259880 A1
(43) Pub. Date: Sep. 18, 2014

(54) CHEMICAL DOSAGE DISPENSER

(71) Applicant: Frank Gigliotti, Somerville Victoria (AU)

(72) Inventors: Frank Gigliotti, Somerville Victoria (AU); Jim Morris, Mont Albert Victoria (AU); Peter Domelow, Heathmont Victoria (AU); Michael Lindeman, Footscray Victoria (AU)

(73) Assignee: Frank Gigliotti, Somerville Victoria (AU)

(21) Appl. No.: 14/217,558

(22) Filed: Mar. 18, 2014

Related U.S. Application Data
(63) Continuation of application No. 13/879,282.

(30) Foreign Application Priority Data
Oct. 12, 2010 (AU) 2010904560

(51) Int. Cl. A01M 7/00

(52) U.S. Cl. CPC A01M 7/0025
USPC 43/131

(57) ABSTRACT

A chemical dosage dispenser (10) including a reservoir (26) containing an aerosol based chemical formulation; a bait mount (28) on which a bait or a lure can be mounted, the bait mount (28) being configured to be bitten by a target animal; and an activation arrangement (32) which operatively connects the bait mount (28) and reservoir (26), the activation arrangement (32) moving between a rest position where the reservoir (26) is closed and an activated position where the reservoir (26) dispenses the chemical formulation. In use, a target animal can move the activation arrangement (32) between the rest position and activated position by moving the bait mount (28).

### FIELD OF THE INVENTION

The present invention generally relates to a chemical dosage dispenser, more particularly an aerosol chemical dosage dispenser which provides a dose of a chemical active to a target animal. The invention is particularly applicable for the control, via chemical formulations, of mammal pest species such as foxes and wild dogs or similar and it will be convenient to hereinafter disclose the invention in relation to that exemplary application. However, it is to be appreciated that the invention is not limited to that application and could be used for the delivery of specific doses of chemicals to any target species for varied purposes including for example vaccinations, fertility control agent and other drugs or vitamins.

### BACKGROUND OF THE INVENTION

The following background discussion of the invention is intended to facilitate an understanding of the invention. However, it should be appreciated that the discussion is not an acknowledgement or admission that any of the material referred to was published, known or part of the common general knowledge as at the priority date of the application.

The European red fox (Vulpes vulpes) and wild dogs (Canis domesticus) pose a serious threat to Australian agriculture and its natural biodiversity. A conservative estimate of stock loss in the Australian state of Victoria from fox predation is alone around AU$227.5 million per annum. Foxes are also responsible for the decline of many threatened species in Australia. The control of predator pests in regional and remote Australia is problematic due to inaccessibility, a small labour force and the immense size of the area infested. Although they can be controlled through the use of poison baits, these baits often create a potential risk to non-target species. Thirty-one quadrupedal endemic mammals in south-eastern Australia are considered to be potentially bait-consuming. A variety of baits can be buried to avoid attracting some species. However foxes exhibit a caching behaviour where they remove and relocate the bait some distance away in a shallow dug-out as a food store. This can negate any advantages in burying the bait and create a potential risk of exposure to non-target native species and working dogs to these poison baits.

One device developed to provide a greater level of target specificity is the United States originating M44 ejector. This device is currently under review for registration in Australia. This device includes a bait receptacle mounted on a spring biased trigger. The trigger operates a piston which is configured to move through a chemical formulation chamber containing a toxin formulation, such as sodium cyanide, located within the bait receptacle. Operation of the trigger doses the animal which triggered the device with the toxin formulation. The bait comprises a member the animal can grasp between its teeth and pull. The trigger is operated when the animal exerts sufficient pull force to activate the device. The M44 ejector provides only a single dose of toxin and needs to be reset with further toxin and bait after each application.

Current baiting techniques, including the M44 ejector, rely on a meat bait to attract the target species to the device. While various bait types (manufactured and natural) have been used with varying degrees of success, their longevity and attractiveness under field conditions is limited and require continual replacement.

It would therefore be desirable to provide an alternative chemical formulation delivery device which can be used repetitively to control a target species.

### SUMMARY OF THE INVENTION

According to the present invention, there is provided a chemical dosage dispenser including:

a reservoir containing an aerosol based chemical formulation;

a bait mount on which a bait or a lure can be mounted, the bait mount being configured to be bitten by a target animal; and

an activation arrangement which operatively connects the bait mount and reservoir, the activation arrangement moving between a rest position where the toxin reservoir is closed and an activated position where the reservoir dispenses the chemical formulation;

wherein, in use, a target animal can move the activation arrangement between the rest position and activated position by moving the bait mount.

The present invention therefore comprises an aerosol chemical dosage dispenser which doses a target animal with an amount of chemical formulation dispensed as a result of the animal operating the activation arrangement. The activation arrangement is typically operated by the target animal biting the bait mount and then moving the bait mount, preferably with their mouth.

When biting the bait or lure, the target animal is likely to move its head, pull or conduct other actions in its attempts to obtain the bait from the bait mount. Most typically, a target animal will attempt to pull the bait from the mount. The activation arrangement is therefore preferably configured so that the target animal can move the activation arrangement between the rest position and activated position by pulling the bait mount.

The chemical dosage dispenser may be configured as a single dose dispenser. However, it is more typically configured as a multi-dose dispenser which resets after a target animal is dosed with chemical formulation to provide a further dose of chemical formulation to a further target animal. The activation arrangement is therefore preferably arranged to move back to the rest position after being moved to the activated position by a target animal to reset the chemical dosage dispenser. This movement can be facilitated by using a biasing means which biases the activation arrangement towards the rest position. The biasing means can be any resilient member capable of providing a force which moves the activation arrangement towards the rest position. Preferably, the biasing means includes at least one spring or at least one magnet. In one exemplary embodiment, the biasing means includes at least one pair of magnets. The poles of each magnet are arranged to attract each other and thus provide a biasing force between the two members.

The force of the biasing means can be selected to provide a desired resistance to move the activation arrangement to the activated position to dispense a dose of chemical formulation. This can allow the dispenser to be configured to only be activated by a target animal of a certain size which is able to exert that designated force when moving the bait mount. For example, in Australia, is it desirable to substantially prevent native animals activating the chemical dosage dispenser whilst still allowing target species, such as a red fox or a wild dog, to activate the chemical dosage dispenser. It has been found that a biasing means which necessitates a minimum activation force of at least 15 N can limit the number of animals that can activate the chemical formulation dispenser to as few as 10% of non-target animals whilst still including the target animals. The number of native animals able to activate the chemical dosage dispenser is further reduced by designing the biasing means with a minimum necessary force of at least 26 N to move the activation arrangement to the activated position.

An exclusion collar substantially extending around the bait mount can further limit the type of species that can access the bait mount to move the activation arrangement to the activated position. The exclusion collar can be configured to only allow animals having a selected head and/or mouth morphology to access the bait mount. Various shape configurations can be placed around the bait mount. For example, the exclusion collar can include an opening shaped and sized to fit the nose and jaws of the selected animal. In another form, the exclusion collar can include an opening shaped and sized to restrict the head size and/or shape of a target animal from accessing the bait mount. Therefore, in Australia, an exclusion collar can be configured to allow only a fox to access the bait mount.

The bait mount can be integral with or separate to the activation arrangement. In one preferred form, the bait mount is a separate element which can be releasably connected to the activation arrangement. For example, in one exemplary form the bait mount comprises a spindle on which bait is mounted. The spindle is preferably threadly connected to the activation arrangement.

The activation arrangement can have any suitable configuration. In one form, the activation arrangement includes a first member on which the bait mount is secured and a second member mounted to a ground engaging portion of the chemical dosage dispenser. The biasing means acts between the first and second member. The first member can also be operatively connected to the reservoir so that movement of the first member relative to the second member causes the reservoir to dispense the chemical formulation. The second member may also include a nozzle that is fluidly connected to an opening on the reservoir through which chemical formulation is dispensed. The nozzle extends through the mount such that in use, the nozzle is located in the animals mouth when the target animal bites the mount. The chemical formulation can be directly dosed into the target animal's mouth to ensure that the chemical formulation is delivered to a location from which it will be ingested, breathed or otherwise absorbed by that animal.

The reservoir can be any suitable container or dispensing device capable of dispensing an aerosol spray of chemical formulation. Any suitable pressurisable vessel could be used. Suitable examples include air pump vessels, pressurised aerosol dispenser, aerosol cans or similar.

It can be important to dose an animal with an exact and predictable amount of chemical formulation to ensure a sufficient dose is ingested to provide the required effect. For example, where the chemical formulation is a toxin, it is preferred the dose administered to the target animal is a lethal dose. A metering device can be connected to the reservoir to deliver a metered amount of chemical formulation from the reservoir when the activation arrangement is moved to the activated position. The metering device is preferably set to dispense a lethal dose of chemical formulation to the target animal.

It can also be important to restrict an animal from administering multiple doses of the chemical formulation once that animal has injested a sufficient dose of the chemical formulation. In some forms, the activation arrangement may therefore include a reset delay mechanism which restricts or slows the activation arrangement from moving between the activated position to the rest position once chemical formulation has been dispensed from the reservoir. The reset delay mechanism can restrict or slow the activation arrangement from moving from the activated position to the rest position and/or prevent movement of the activation arrangement from moving from the rest position to the activated position for a predetermined time after a preceding activation movement between those two positions. The reset delay mechanism may comprise any suitable device. For example, in one embodiment, the reset delay mechanism includes a biasing mechanism which slows movement of the activation arrangement from the activated position to the rest position or similar.

In another forms, reset delay mechanism may include a timing mechanism, such as an electronic timing mechanism, to introduce a programmable delay after the reservoir dispenses the chemical formulation. The timing mechanism may comprise any suitable device. In some forms, the timing mechanism could include a controlled solenoid which drives movement of a locking device which can be moved to inhibit movement of the activation arrangement. In other forms, the timing device could include a valve which can be used to selectively restrict the the chemical formulation from being dispensed from the reservoir, preferably even when the activation arrangement is moved to the activated position.

In yet other forms, reset delay mechanism may include an expanable member such as a tie fitting tube and/or bladder fitted in or in communication with the reservoir which is vented into a deployment reservoir. When the activation arrangement is moved to the activated position the tube/bladder is actuated to draw in air which then inhibits movement of the activation arrangement back to the rest position.

The chemical formulation can be neat or co-formulated with excipients to (i) aid aerosolization, (ii) chemical dispersion, and/or (iii) assist chemical uptake, adsorption, absorption or the like of the chemical in the target animal. The chemical formulation can be any desired chemical which is desired to be administered to a target animal. In some embodiments, the chemical formulation includes a toxin. However, it should be appreciated that the chemical formulation could be any other desired chemical formulation such as a fertility control agent, other drugs or vitamins.

Where the chemical formulation is a toxin formulation. it is generally selected to the specific lethal needs of a particular target species. For quadrupedal mammals, the toxin formulation can be selected from at least one of sodium fluoroacetate, sodium cyanide, para-aminoproppiophenone, terbufos, or T3327 (tubulysin A).

Traps or chemical dosage dispensers set in remote locations, such as the Australian Outback, presently use perishable bait such as meat to lure target animals. This type of bait has a life of several days at the most, even when buried. The field life of these and the present invention can be extended by using a long life bait or lure. A number of potential long life baits are presently available, including impregnated plastic or a porous material soaked in an attractant. Suitable porous materials include leather, cork, synthetic cork, porous polymers such as foam rubber or the like.

The chemical dosage dispenser of the present invention can be configured to be mounted on the ground or a low level surface. The dispenser can therefore include a ground engaging section which mounts the dispenser in a stable position on the ground. The ground engaging section may include one or more legs, platforms or wheels. However, in a preferred configuration the ground engaging portion includes an insertion portion that is configured to be releasably inserted into the ground. The insertion portion may include a threaded section which can be screwed into a suitable hole in the ground to releasably retain the dispenser at that location. The dispenser can be any shape, but is preferably substantially tubular.

### BRIEF DESCRIPTION OF THE DRAWINGS

The present invention will now be described with reference to the figures of the accompanying drawings, which illustrate particular preferred embodiments of the present invention, wherein:

FIG. 1 is a perspective view of one embodiment of a chemical dosage dispenser according to the present invention.

FIG. 2 is an exploded view of the chemical dosage dispenser shown in FIG. 1.

FIG. 3 is a top view showing the access detail to a bait mount of the chemical dosage dispenser shown in FIGS. 1 and 2.

FIG. 4 is a perspective view of the chemical formulation dispensing arrangement of the chemical dosage dispenser shown in FIGS. 1 and 2.

FIG. 5 is a base view of an activation arrangement of the chemical formulation dispensing arrangement shown in FIG. 4.

FIG. 6 is a cross-sectional side view the chemical dosage dispenser shown in FIG. 1.

FIG. 7 is a cross-sectional front view the chemical dosage dispenser shown in FIG. 1.

### DETAILED DESCRIPTION

FIGS. 1 to 7 illustrate one form of a chemical dosage dispenser 10 according to the present invention. The illustrated chemical dosage dispenser 10 is configured to dispense a fatal dose of toxin formulation to a European red fox (Vulpes vulpes). The European red fox is a pest in all of the states of Australia, and the illustrated chemical dosage dispenser 10 has been developed to assist in controlling the fox population in Australia. However, it should be understood that the configuration of this chemical dosage dispenser 10 could be modified to suit any number of animals such as rodents, dogs, bears, coyotes, or the like without departing from the spirit or scope of the present invention.

Referring firstly to FIGS. 1 and 2, the illustrated chemical dosage dispenser 10 can be seen to comprise a substantially tubular housing 12 which includes an exclusion collar 14, toxin dispensing arrangement 16, and ground engaging screw 18. Each of these sections 14, 16 and 18 are releasably coupled together using a locking arrangement 20, best shown in FIG. 2. The locking arrangement 20 comprises an elongate recess 22 and pin 24 which are interlocked by axially inserting the pin 24 into the recess and then annularly twisting the respective sections 14, 16 and 18 to lock the pin into the recess 22.

A toxin formulation is dispensed to a target animal using the toxin dispensing arrangement 16. The illustrated toxin dispensing arrangement 16 includes a toxin reservoir 26 comprising an aerosol can containing an aerosolisable toxin formulation; a bait mount 28 on which a bait 30 is mounted; and an activation arrangement 32. The activation arrangement 32 operatively connects the bait mount 28 and toxin reservoir 26 and functions to release a toxin formulation from the reservoir 26 when the bait mount 28 is bitten and pulled by a target animal (not illustrated).

As best shown in FIGS. 2, 4, 6 and 7, the illustrated bait mount 28 comprises a tubular spindle 29 on which the bait 30 is mounted. The spindle 29 includes a central threaded passage 31 (only shown in FIG. 2) which is threaded onto a nozzle conduit 38. The nozzle conduit 38 houses a nozzle 39 which extends from the toxin reservoir 26 through the spindle 29 and to the top of the bait mount 28 to position the dispensing opening 35 of the toxin reservoir 26 within the mouth of a target animal when that animal is biting the bait mount 28.

The illustrated bait 30 comprises a series of leather washers 33 which can be soaked in a suitable attractant. This type of bait 30 is one form of long life bait which can be used in the chemical dosage dispenser 10. Long life bait can be particularly useful when setting this chemical dosage dispenser 10 in remote locations, such as the Australian Outback. It should be understood that other types of baits, such as meat baits or other long life baits such as impregnated plastic could also be used without departing from the spirit or scope of the present invention.

The activation arrangement 32 includes a pull member 34 and a dispensing mount 36. As best shown in FIG. 2, the pull member 34 includes a nozzle conduit 38 configured to extend through the central threaded passage 31 of the spindle 29 of the bait mount 28. The nozzle conduit 38 includes an outer thread 40 (FIG. 2) which cooperates with the inner thread (not illustrated) of the central threaded passage 31 of the spindle 29 to lock the bait mount 28 onto the pull member 34. The pull member 34 also includes two axially extending legs 42 (relative to axis X-X best shown in FIGS. 2, 6 and 7) which include an inner annular lip or recess 44 designed to lock over a corresponding lip, ledge or bead 46A located on the top of the toxin reservoir 26. As shown in FIGS. 6 and 7, the top of the toxin reservoir 26 is releasably retained between the legs 42 by insertion of the top of the toxin reservoir 26 between those legs 42.

The legs 42 extend through complementary shaped openings 46 in the dispensing mount 36. The dispensing mount 36 is a disc shaped member which functions to connect the toxin dispensing arrangement 16 to the housing 12. The dispensing mount 36 therefore includes two sets of locking pins 24 which interact with elongate recesses 22 in each of the exclusion collar 14, and ground engaging screw 18 to lock these sections together. The dispensing mount 36 also includes nozzle 39 which extends from the toxin reservoir 26 through the spindle 29 and to the top of the bait mount 28 to position the dispensing opening of the toxin reservoir 26 within the mouth of a target animal when that animal is biting the bait mount 28. Toxin formulation can be directly dosed into the target animal's mouth to ensure the toxin formulation is delivered to a location from which it will be ingested, breathed or otherwise absorbed by that animal. As best illustrated in FIG. 5, the base of the dispensing mount 36 includes a nozzle recess 47 that is also configured to receive and abut the upper end of the toxin nozzle 48 (FIG. 4) of the toxin reservoir 26 and allow this toxin nozzle 48 to be depressed.

In operation, the legs 42 of the pull member 34 are inserted through openings 46 (FIGS. 2 and 4) of the dispensing mount 36 with the top of the toxin reservoir 26 being locked between the legs 42 of the pull member 34 and the top of the toxin reservoir 26 abutting or being located closely proximate to the bottom of the dispensing mount 36. This also aligns the toxin nozzle 48 of the toxin reservoir 26 with the nozzle recess 47. Therefore, axial movement of the pull member 34 along axis X-X in a direction away from the dispensing mount 36 depresses the toxin nozzle 48 of the toxin reservoir 26, causing toxin formulation to be dispensed through the nozzle 39 of the activation arrangement 32. The activation arrangement 32 is typically operated by the target animal biting the bait mount 28 and then pulling on the bait mount 28 with it in their mouth.

The illustrated chemical dosage dispenser 10 is configured as a multi-dose dispenser which resets after a target animal is dosed with toxin formulation to provide a further dose of toxin formulation to a further target animal. The activation arrangement 32 is therefore arranged to move back to a closed position after being moved activated by a target animal to reset the chemical dosage dispenser 10. As best shown in FIG. 6, a magnetic biasing means 49 acts between the pull member 34 and dispensing mount 36 to bias the pull member 34 and the dispensing mount 36 together. The magnetic biasing means 49 includes two pair of magnets 50 set in adjoining positions in the pull member 34 and the dispensing mount 36. The illustrated magnets 50 are rare earth ceramic ferrite magnets encased in stainless steel housings, though it should be appreciated that any suitable magnets could be used. The magnetic attraction and strength of this type of magnetic biasing means 49 remains substantially constant. In contrast, strict manufacturing quality control is required to achieve a constant spring based biasing means. Additionally, it should be appreciated that the use of magnetic biasing means 49 provide a sudden release once the designed resistance force is exceeded. Thus, there is no drag with increasing resistance as is provide by a spring type biasing means. In contrast, there is a resistance and then no resistance once the activation arrangement 32 is released, ensuring a target animal is suddenly dosed with the desired chemical formulation.

The poles of each pair of magnets 50 in each of the pull member 34 and the dispensing mount 36 are orientated to attract each other. The force of the magnetic biasing means 49 is selected to provide a desired resistance to movement of the pull member 34 away from dispensing mount 36 to a position in which toxin formulation is dispensed from the toxin reservoir 26. In the illustrated embodiment, the pull force of the two magnets 50 is ˜10,000 gauss. This allows the dispenser 10 to be configured to only be activated by a target animal of a certain size which is able to exert that designed force when moving the bait mount 28. For example, in Australia it is desirable to limit the number of native animals that can activate the chemical dosage dispenser 10 whilst still allowing target species such as a red fox or a wild dog to activate the chemical dosage dispenser 10. It has been found that a biasing means which provides a minimum force of at least 15 N can limit the number of animals that can activate chemical dosage dispenser 10 to as few as 10% whilst still including the target animals. This is further reduced by designing the magnetic biasing means 49 with a minimum force of at least 26 N to move the activation arrangement 32 to the activated position. Generally only an animal which is 3 kg in weight or heavier would be able to exert this minimum force.

While not illustrated, it should be appreciated that the activation arrangement 32 may a reset delay mechanism which restricts or slows the activation arrangement from moving from the activated position to the rest position. The reset delay mechanism may comprise any suitable device, for example, a biasing mechanism which slows movement of pull member 34 and the dispensing mount 36 or similar. Another possible mechanism includes an electrically controlled mechanical inhibitor of movement of the activation arrangement 32 using for example a solenoid (not illustrated) which drives movement of a locking pin into or out from a position which inhibits movement of the activation arrangement 32. Another possible mechanism includes an electrically controlled inhibitor preventing movement of the toxin nozzle 48 of the toxin reservoir 26. This could be achieved using an electric valve.

In other forms contemplated by the Applicant, the toxin nozzle 48 of the toxin reservoir 26 could be positioned in the timing mechanism with the nozzle 48 depressed and an electrically operated valve determining release. The duration of release of the chemical formulation from the toxin reservoir 26 (dose) and the delay between doses could easily be controlled. Alternatively, a solenoid could depress the nozzle 48 to provide a controllable dispensing mechanism. It is noted that the activation arrangement 32 described above would require modification to accommodate this mechanism. In this respect, the activation device would operate a switch (not illustrated) rather than directly trigger the toxin nozzle 48 of the toxin reservoir 26. The switch would triggers the timing mechanism which, by operating the valve (or solenoid), delivers the required dose. This also initiates the timing period before the next dose can be delivered. It is considered that these modifications would be well understood in the art and could be achieved by a person skilled in the art. In some embodiments, the dose of toxin from the toxin reservoir 26 could be restricted at different times of day to increase species specificity.

Whilst not illustrated, it should be understood that a metering device can be connected to the toxin reservoir 26 to deliver a metered amount of toxin formulation in order to dose an animal with an exact amount of toxin formulation to ensure a lethal dose is ingested. The metering device is preferably set to dispense a lethal dose of toxin formulation to the target animal. The metering device can be a metered dose valve which delivers a repeated measured dose of substance directly into a target animal's mouth. The direct aerosol delivery of the toxin formulation into the animals' mouth overcomes issues of sub-lethal dosing, and increases uptake of the substance across the mucous membranes.

The toxin formulation in the toxin reservoir 26 is generally selected to be specifically lethal to the particular target species. For quadrupedal mammals such as foxes, the toxin formulation can be selected from at least one of sodium fluoroacetate, sodium cyanide, para-aminoproppiophenone, terbufos or T3327 (tubulysin A).

The target specificity of the illustrated chemical dosage dispenser 10 is achieved by the combination of the species access restriction provided by the exclusion collar 14 and the pulling force required to operate the activation arrangement 32. Large native species such as adult spotted-tail quolls and adult Tasmanian devils are capable of generating the 3 kg pull force due to their size. However, the exclusion collar 14 can substantially eliminate any risk of exposure to these non-target species.

The exclusion collar 14 comprises a tubular element which is coupled over and substantially around the bait mount 28. The exclusion collar 14 includes an access opening 52 (best shown in FIGS. 3, 6 and 7) which is sized to limit the type of species which can access the bait mount 28, and therefore trigger the release of toxin formulation from the toxin reservoir 26. The exclusion collar 14 can be configured to only allow animals having a selected head and mouth morphology access the bait mount. In this respect, the access opening 52 is shaped and sized to fit the nose and jaws of the selected animal, a European red fox. However, it should be appreciated that the access opening 52 could be configured to suit head and mouth morphologies of various other animals, such as rodents or similar.

The illustrated exclusion collar 14 has been fabricated to the design and specifications reported in Nicholson and Gigliotti (2005). Increasing the target specificity of the M-44 elector by exploiting differences in head morphology between foxes and large dasyurids. Wildlife Research 32: 7333-736, the contents of which are to be understood to be incorporated into this specification by this reference. The design of the illustrated exclusion collar 14 is based on the differences in head morphology between the target species, the red fox, the spotted-tail quell (Dasyurus maculatus) and the Tasmanian devil (Sarcophilus harrisii).

The illustrated chemical dosage dispenser 10 is configured to be mounted on the ground or a low level surface. The dispenser 10 includes a threaded ground engaging screw section 18 which is designed to be screwed into the ground to mount the dispenser 10 in a stable position on the ground, with the access opening 52 in a substantially upwardly facing direction, relative to the surface of the ground. In hard terrain, a hole may be preformed, for example pre-made using an auger. to receive the screw section 18. In lighter, softer soils, such as sandy or loamy soils, the screw section 18 may be simply pushed or screwed into the soil surface.

The screw section 18 includes a coarse thread 54 which creates an interference fit when inserted into the ground, anchoring the chemical dosage dispenser 10 into that position. The screw section 18 also allows the chemical dosage dispenser 10 to be permanently fixed into the ground forming long-term sentinel sites that can be continually active or the housing capped when not in use and reactivated when required.

### EXAMPLE

A preliminary trial of the collar 14 was conducted. The trial was designed as a free choice, behavioural observation, to assess the fox's behaviour towards the collar and their ability and willingness the retrieve a morsel of fresh liver from within a collar 14. The collar 14 was secured to a base plate and foxes were allowed to examine the collar 14 and retrieve the liver. There were no unexpected or neophobic behaviour exhibited by the foxes to the collar other than an expected initial hesitation to a new foreign object but this was quickly overcome by curiosity.

Those skilled in the art will appreciate that the invention described herein is susceptible to variations and modifications other than those specifically described. It is understood that the invention includes all such variations and modifications which fall within the spirit and scope of the present invention.

Where the terms “comprise”, “comprises”, “comprised” or “comprising” are used in this specification (including the claims) they are to be interpreted as specifying the presence of the stated features, integers, steps or components, but not precluding the presence of one or more other feature, integer, step, component or group thereof.

1. A chemical dosage dispenser including:
a reservoir containing an aerosol based chemical formulation;
a bait mount on which a bait or a lure can be mounted, the bait mount being configured to be bitten by a target animal; and
an activation arrangement which operatively connects the bait mount and reservoir, the activation arrangement moving between a rest position where the toxin reservoir is closed and an activated position where the reservoir dispenses the chemical formulation;
wherein, in use, a target animal can move the activation arrangement between the rest position and activated position by moving the mount.

2. A chemical dosage dispenser according to claim 1, wherein the target animal can move the activation arrangement between the rest position and activated position by pulling the bait mount.

3. A chemical dosage dispenser according to claim 1 or 2, wherein the activation arrangement moves back to the rest position after being moved to the activated position by a target animal to reset the chemical dosage dispenser for further use.

4. A chemical dosage dispenser according to any preceding claim, further including a biasing means biasing the activation arrangement towards the rest position.

5. A chemical dosage dispenser according to any preceding claim, wherein the biasing means includes at least one spring or at least one magnet.

6. A chemical dosage dispenser according to claim 5, wherein the biasing means includes at least one pair of magnets.

7. A chemical dosage dispenser according to claim 5 or 6, wherein the biasing means provides a minimum force of at least 15 N, preferably at least 26 N to move the activation arrangement to the activated position.

8. A chemical dosage dispenser according to any preceding claim, further including an exclusion collar substantially extending around the bait mount, the exclusion collar being configured to only allow animals having a selected head and/or mouth morphology access the bait mount.

9. A chemical dosage dispenser according to claim 8, wherein the exclusion collar includes an opening shaped and sized to fit the nose and jaws of the selected animal.

10. A chemical dosage dispenser according to claim 8 or 9, wherein the exclusion collar is configured to allow a fox to access the bait mount.

11. A chemical dosage dispenser according to any preceding claim, wherein the activation arrangement includes a first member on which the bait mount is secured and a second member mounted to a ground engaging portion of the chemical dosage dispenser, the biasing means acting between the first and second member.

12. A chemical dosage dispenser according to claim 11, wherein the first member is operatively connected to the reservoir so that movement of the first member relative to the second member causes the reservoir to dispense the chemical formulation.

13. A chemical dosage dispenser according to claim 11 or 12, wherein the second member further includes a nozzle fluidly connected to an opening on the reservoir through which chemical formulation is dispensed, the nozzle extending through the mount such that in use, the nozzle is located in the animals mouth when the animal bites the mount.

14. A chemical dosage dispenser according to any preceding claim, further including a metering device connected to the reservoir to deliver a metered amount of chemical formulation from the reservoir when the activation arrangement is moved to the activated position.

15. A chemical dosage dispenser according to claim 14, wherein the chemical formulation is a toxin formulation and the metering device is set to dispense a lethal dose of the toxin formulation to the target animal.

16. A chemical dosage dispenser according to any preceding claim, further including a reset delay mechanism which restricts or slows the activation arrangement from moving between the activated position to the rest position once chemical formulation has been dispensed from the reservoir.

17. A chemical dosage dispenser according to any preceding claim, wherein the chemical formulation includes at least one of sodium fluoroacetate, sodium cyanide, para-aminoproppiophenone, terbufos or T3327 (tubulysin A).

18. A chemical dosage dispenser according to any preceding claim, wherein the chemical formulation is co-formulated with excipients to (i) aid aerosolization, (ii) chemical dispersion, and/or (iii) assist chemical uptake, adsorption, absorption or the like of the chemical in the target animal.

19. A chemical dosage dispenser according to any preceding claim, wherein the reservoir comprises a pressurised aerosol dispenser.

20. A chemical dosage dispenser according to any preceding claim, wherein the bait or lure includes a long life bait.

21. A chemical dosage dispenser according to claim 20, wherein the long life bait is selected from an impregnated plastic or a porous material soaked in an attractant.

22. A chemical dosage dispenser according to any preceding claim, further including a ground engaging section having an insertion portion that is configured to be releasably inserted into the ground.

22. A chemical dosage dispenser according to claim 22, wherein the insertion portion includes a threaded section.
